(19) United States
(12) Patent Application Publication
(10) Pub. No.: US 2008/0005096 A1
(43) Pub. Date: Jan. 3, 2008

(54) MONETIZATION OF CHARACTERISTIC VALUES PREDICTED USING NETWORK-BASED SOCIAL TIES

(75) Inventor: Paul Cameron Moore, Redwood City, CA (US)

Correspondence Address: BEYER WEAVER LLP, P.O. BOX 70250, OAKLAND, CA, 94612-0250, US

(73) Assignee: YAHOO! INC., Sunnyvale, CA (US)

(21) Appl. No.: 11/427,741

(22) Filed: Jun. 29, 2006

(51) Int. Cl. G06F 17/30

(52) U.S. Cl. 707/5

(57) ABSTRACT

A method is provided to predict a value for a particular characteristic of a particular user of network-based services. A plurality of other users, other than the particular user, is determined, wherein the particular user has social ties to the plurality of other users. The social ties may be discerned, for example, by examining connections provided by the network-based service. In some examples, the social ties may be inferred by other methods as well. A value is predicted for the particular characteristic of the particular user based on values associated with the particular characteristic of the other users, with whom the particular user is determined to have the social ties. The predicted value for the particular characteristic of the particular user is monetized, such as by selling advertising to be caused to be displayed to at least the particular user. For example, requested compensation for the advertising is determined based at least in part on the predicted value for the particular characteristic of the particular user.

### BACKGROUND

It is desired to monetize knowledge of characteristics of people and, more specifically, to monetize values of characteristics of people such as contained in demographic and/or psychographic (attitude) profiles. For example, it may be desired to sell advertising based on such characteristics. Unfortunately, direct information about such values of characteristics is often not easily attainable.

### SUMMARY

A method is provided to predict a value for a particular characteristic of a particular user of network-based services. A plurality of other users, other than the particular user, is determined, wherein the particular user has social ties to the plurality of other users. The social ties may be discerned, for example, by examining connections provided by the network-based service. In some examples, the social ties may be inferred by other methods as well. A value is predicted for the particular characteristic of the particular user based on values associated with the particular characteristic of the other users with whom the particular user is determined to have the social ties.

The predicted value for the particular characteristic of the particular user is monetized, such as by selling advertising to be caused to be displayed to at least the particular user. For example, requested compensation for the advertising is determined based at least in part on the predicted value for the particular characteristic of the particular user.

### BRIEF DESCRIPTION OF THE DRAWINGS

FIG. 1 is a block diagram illustrating a simplistic example of users exercising social ties via network-based connections.

FIG. 2 is a block diagram illustrating an example architecture of a system to predict the value of a particular characteristic (e.g., demographic or psychographic characteristic) for a particular user.

FIG. 3 is a block diagram illustrating how known indications of user characteristics, for users of a control group, may be employed to generate a calibrated function, for processing known indications of user characteristics to predict, for a particular user, a value of the user characteristic that is otherwise unknown or inaccessible.

FIG. 4 is a graph that illustrates an example of applying scoring functions and a calibration term to predict the unknown value of a characteristic of a particular user.

FIG. 5 is a flowchart summarizing an example of processing to predict and use a value of a characteristic of a particular user.

### DETAILED DESCRIPTION

In accordance with a broad aspect, prediction of demographic and/or psychographic characteristics for a particular user is determined based on known information for other users to whom the particular user exercises social ties. More specifically, such social ties are exercised using connections provided by network-based services.

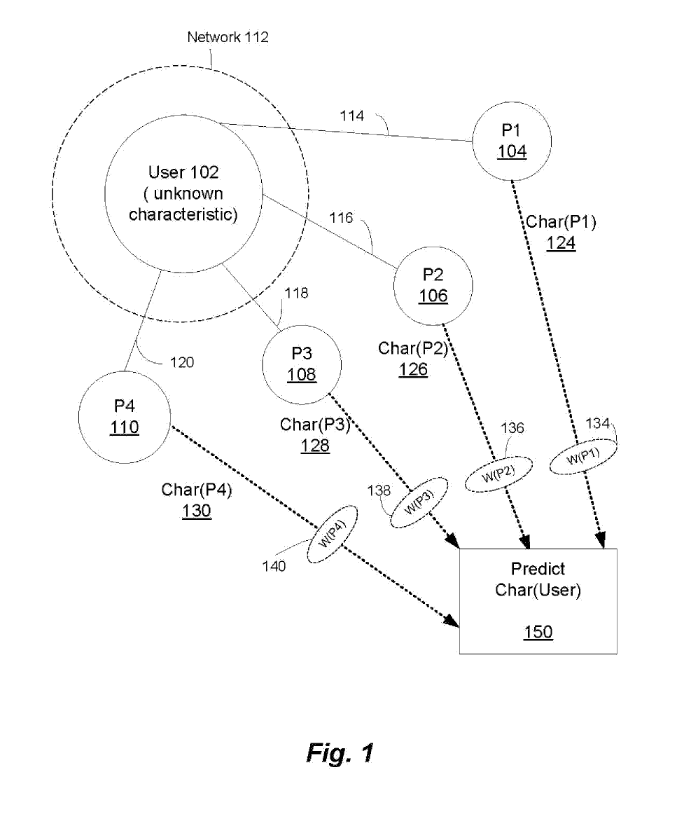

FIG. 1 is a block diagram illustrating a simplistic example of users exercising social ties via network-based connections. Referring to FIG. 1, the particular user for whom a value of a particular characteristic is unknown is the user 102. In the simplistic FIG. 1 example, the user 102 has social ties to users P1 104, P2 106, P3 108 and P4 110. The social ties are exercised using connections 114, 116, 118 and 120, respectively. More particularly, the connections are provided and/or utilized by network-based services, over the network 112. Three examples of such network-based services include e-mail, instant messaging and Yahoo! 360° (a service that facilitates creating a centralized repository of information to share with other users by invitation), but there are numerous other possible network-based services.

Prediction functionality 150 is configured to receive an indication of the value of the particular characteristic for each of user P1 104, P2 106, P3 108 and P4 110. That is, the indications Char(P1) 124, Char(P2) 126, Char(P3) 128 and Char(P4) 130 are provided to the prediction functionality 150. FIG. 1 figuratively illustrates the indications as being provided from the users (which perhaps can be though of as being equivalent to client computers, though this is not a requirement, as a user need not be tied to a particular device). In practice, though, the indications may be provided from wherever they are available.

Moreover, while the indications may originate from profiles maintained relative to providing the services, the indications may also be otherwise obtained from, for example, publicly accessible (or even proprietary) databases unrelated to providing the services. For example, an indication of a political party to which a user contributes may be available from publicly accessible campaign contribution databases. As another example, an indication of a user's ZIP code may be available from publicly accessible telephone directory databases.

Furthermore, the indications may be weighted (in FIG. 1, by weights W(P1) 134; W(P2) 136; W(P3) 138 and W(P4) 140) based, for example, on an attribute of the connection between the particular user and another user, such as an attribute of the social tie exercised via the connection (e.g., family, friend, or colleague) or such as an attribute of the service via which the connection is provided (e.g., e-mail, instant messaging, or photo sharing).

The prediction functionality 150 uses the provided indications (weighted by the weights) to predict the value of the particular characteristic for the user 102. An illustration of processing executed by the prediction functionality 150, to predict the value of the particular characteristic for the user 102, is discussed later.

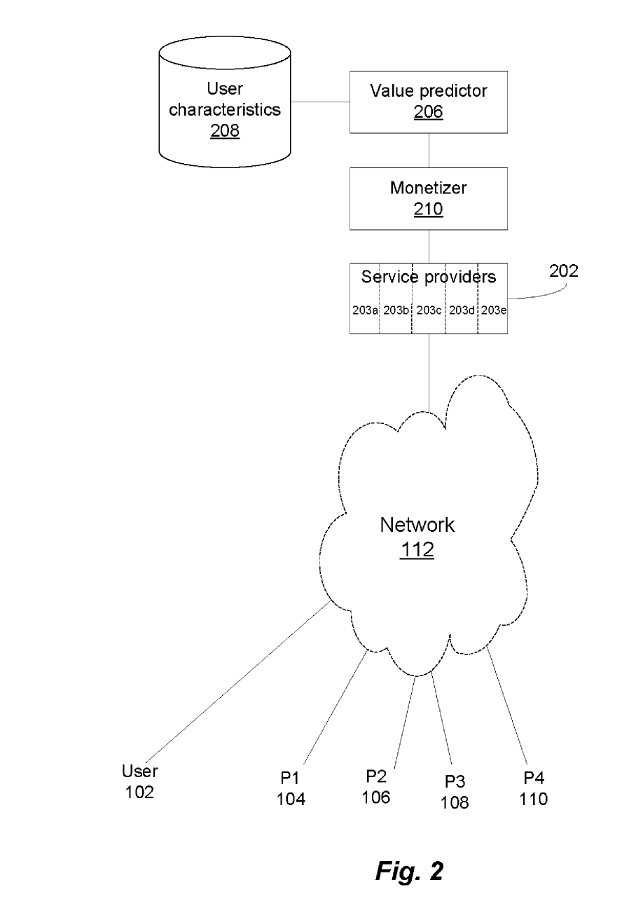

FIG. 2 is a block diagramming illustrating an example architecture of a system to predict the value of a particular characteristic (e.g., demographic or psychographic characteristic) for a particular user. A plurality of users P1 104, P2 106, P3 108 and P4 110 include the particular user 102 (for whom prediction of demographic and/or psychographic characteristics is determined). The users exercise social ties to each other using connections provided by service providers 202 (e.g., individual services 203a to 203e) via the network 112. The network 112 is not limited to being the internet but, rather, should be interpreted expansively to include various networks that connect device users.

Social ties may be inferred by other means as well, not related to use of connections provided by service providers via the network 112. As just one example, a telephone directory database may be processed and, based thereon, it may be determined that two people having the same last name live at the same address. It can be inferred from this information, with some degree of certainty, that these two people have a social tie (family).

Indications of user characteristics are held in data storage 208 accessible to the service provider 202 which may include, for example, profiles of the users related to use of the services. While the data storage 208 may include a profile database, the data storage 208 may also include, as mentioned above, publicly available or proprietary information not related to use of the services. Further, in some examples, the database is not centralized but, rather, is distributed (e.g., values of characteristics of a user are stored in association with that user, perhaps even on or closely associated with a device used by that user).

A value predictor 206 uses the indications of user characteristics and social ties for each users held in the data storage 208 to predict a value for a particular characteristic of the user 102. The monetizer 210 monetizes the predicted value. For example, the predicted value may be used to determine whether to cause the display of particular advertising to the user 102. The advertising may be displayed in conjunction with, and based on, other display of information. The monetization is a result of collecting money to display the advertisement (and/or as a result of the user taking action with respect to display of the advertisement, such as clicking on a link associated with the advertisement or interacting with a web site linked to by the advertisement).

The advertisement display may be associated with displaying search results, where depending on the predicted value of the particular characteristic for the particular user, advertising is selectively caused to be concurrently displayed with results of “sponsored search” processing. That is, in addition to causing search results to be displayed, the search engine (or software associated with or otherwise in communication with the search engine) nominally also causes one or more sponsored advertisements to be displayed to the user based on the search query keywords provided by the user. In this example, a determination of which sponsored advertisements to cause to be displayed to the particular user may be further based on the predicted value of the particular characteristic of the user.

The advertising display may also include contextual advertising, which is advertising that is caused to be displayed on a web page based on the content of the web page. A determination of which advertisements to cause to be displayed to the particular user may be further based on the predicted value of the particular characteristic of the particular user.

The monetization may not be via display advertising but, rather, may include other uses of the predicted value of the particular characteristic of the particular user. For example, the monetization may include sale of mailing lists, targeted e-mail, or many other monetization vehicles.

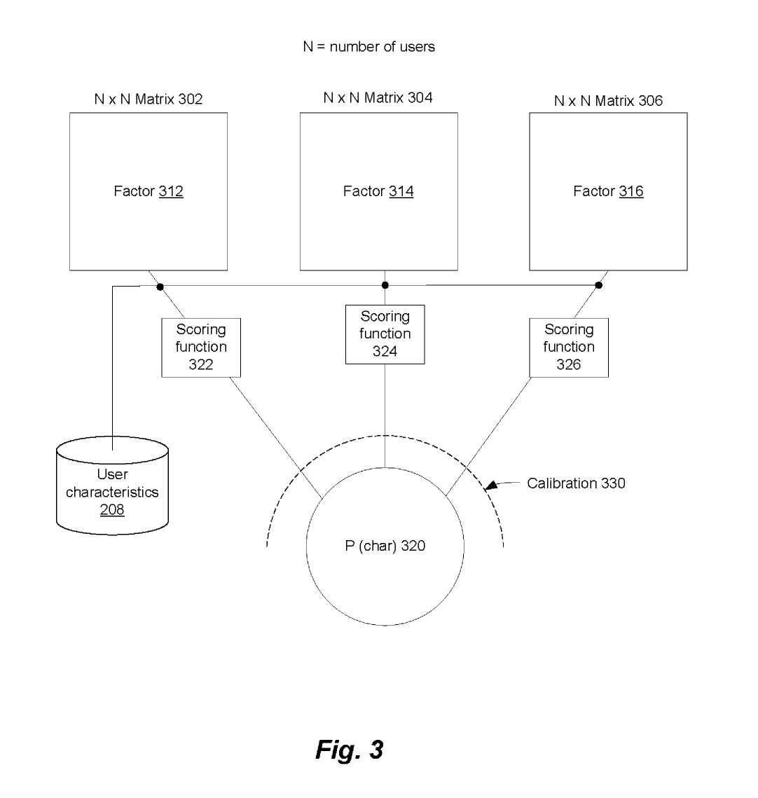

We now turn to FIG. 3, which is a block diagram illustrating how known indications of user characteristics, for users in a control group, may be employed to generate a calibrated function, for processing known indications of user characteristics to predict, for a particular user, a value of the user characteristic that is otherwise unknown or inaccessible. In FIG. 3, N indicates the number of users in the control group. Each N×N matrix (in this case, three matrices 302, 304 and 306) represents how users in the control group are socially tied to one another. There can be different and multiple matrixes for different combinations (“tuple”) of characteristic, source (e.g., instant messaging or e-mail) and type (e.g., family, friend, or colleague). The social tie matrix, when combined with user characteristics 208 of the control group, create a different factor (factors 312, 314 and 316, respectively) that may be employed to predict the user characteristic.

Based on known values for the characteristic of the control users 320, each scoring function 322, 324 and 326 is determined. For example, each scoring function may be thought of as a coefficient for one term of a polynomial function for processing the particular factor to which that scoring function corresponds. For example, the polynomial function may be determined using regression analysis. In addition, a calibration term 330 is determined. Using the polynomial function example, the calibration term 330 may be thought of as a constant baseline term. Once the scoring functions 322, 324 and 326, and the calibration term 330, have been determined, these scoring functions and calibration term may be applied to other N×N matrices to predict the value (unknown) of a characteristic of a particular user.

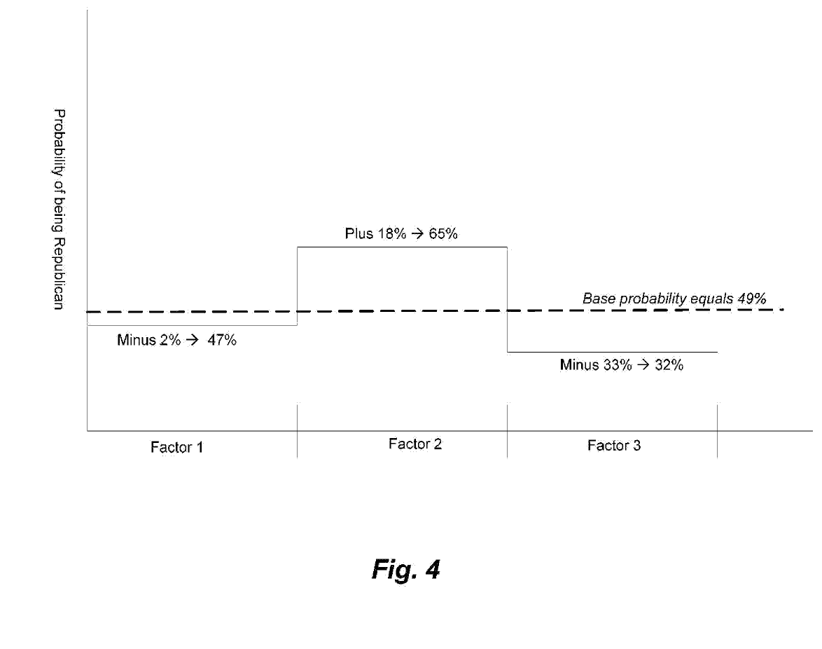

FIG. 4 is a graph that illustrates an example of applying scoring functions and a calibration term to predict the unknown value of a characteristic of a particular user. In the FIG. 4 example, the characteristic is being a member of the Republican party, and the predicted value indicates a probability of the user being a member of the Republican party. In the general population, according to the example, the probability of being a Republican is 49%. This is calculated using the user characteristics of the known population. Applying Factor 1 (that is, processing the known characteristics of the particular user versus other users, with whom the particular user exercises social ties via network-based services, with characteristic, source of connection and type of social tie corresponding to Factor 1), the probability of the particular user being a Republican is lowered by 2%. Applying Factor 2, the probability of the particular using being a Republican is raised by 18%. Finally, applying Factor 3, the probability of the particular user being a Republican is lowered by 33%. The resultant predicted probability of the particular user being a Republican is thus 32%.

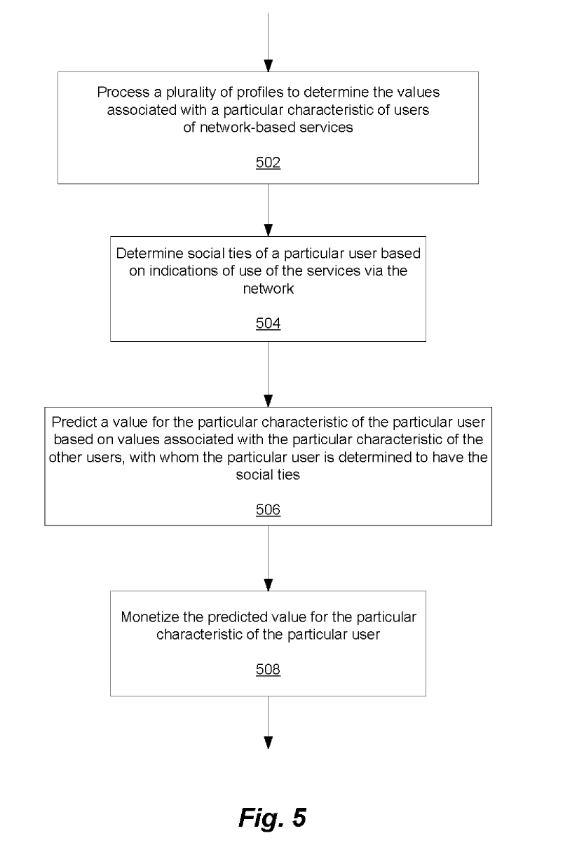

FIG. 5 is a flowchart summarizing an example of processing to predict and use a value of a characteristic of a particular user. At step 502, a plurality of profiles are processed to determine the values associated with a particular characteristic of users of network-based services. At step 504, social ties of the particular user are determined based on indications of use of the services via the network. At step 506, a value is predicted for the particular characteristic of the particular user based on values associated with the particular characteristic of the other users, with whom the particular user is determined to have the social ties. The value is predicted, for example, in view of attributes of the connection between the particular user and each other user—such as attributes of the social tie and the type of the connection. At step 508, the predicted value for the particular characteristic of the particular user is monetized.

Thus, for example, if the predicted value has associated with it a percent probability, this percent probability may be useful in monetizing the predicted value. For example, an advertiser may wish to target advertising to users who are determined, with higher than a certain probability, to have a certain characteristic. The more focused a group of users the media provider can target, then the advertiser may be willing to pay higher amounts for such advertising. It is believed that, using social ties as herein described, the probabilities can be predicted with better-than-chance statistical accuracy.

What is claimed is:

1. A method of predicting a value for a particular characteristic of a particular user of network-based services, comprising:
determining a plurality of other users, other than the particular user, with whom the particular user has social ties, wherein the particular user has social ties to the plurality of other users using connections provided by the network-based services; and
predicting a value for the particular characteristic of the particular user based on values associated with the particular characteristic of the other users, with whom the particular user is determined to have the social ties.

2. The method of claim 1, further comprising:
processing a plurality of profiles to determine the values associated with the particular characteristic of the other users, with whom the particular user is determined to have the social ties.

3. The method of claim 2, wherein:
the plurality of profiles include profiles related to use of the service.

4. The method of claim 2, wherein:
the plurality of profiles include profiles not related to use of the service.

5. The method of claim 1, further comprising:
monetizing the predicted value for the particular characteristic of the particular user.

6. The method of claim 5, wherein:
the monetizing step includes selling advertising to be caused to be displayed to at least the particular user.

7. The method of claim 5, wherein:
the monetizing step includes selling advertising to be caused to be displayed to at least the particular user, via the network.

8. The method of claim 6, wherein:
determining requested compensation for the advertising is based at least in part on the predicted value for the particular characteristic of the particular user.

9. The method of claim 1, wherein:
the step of predicting the value for the particular characteristic of the particular user includes, for each of the other users with whom the particular user is determined to have social ties, applying a weighting to the value associated with the characteristic of that other user based on an attribute of the connection via which the particular user exercises a social tie with that other user.

10. The method of claim 9, wherein:
the attribute of the connection includes an attribute of the social tie exercised via the connection.

11. The method of claim 9, wherein:
the attribute of the connection includes an attribute of the service provided on the connection via which the social tie is exercised.

12. The method of claim 9, further comprising:
determining the weighting to apply to the value associated with the property of that other user by employing at least one particular calibration user, for whom the value associated with the property is known, and determining the weighting based on, for each of a plurality of other calibration users with whom the at least one particular calibration user has social ties via the connections, other than the at least one particular calibration user, a value of the property of that other calibration user and an attribute of the connection via which the at least one particular calibration user has a social tie with that other calibration user.

13. A computing device operable to perform the method of claim 1.

14. A computer program product to predict a value for a particular characteristic of a particular user of network-based services, the computer program product comprising at least one computer-readable medium having computer program instructions stored therein which are operable to cause at least one computing device to:
determine a plurality of other users, other than the particular user, with whom the particular user has social ties, wherein the particular user has social ties to the plurality of other users using connections provided by the network-based services; and
predict a value for the particular characteristic of the particular user based on values associated with the particular characteristic of the other users, with whom the particular user is determined to have the social ties.

15. The computer program product of claim 14, wherein:
the computer program instructions are further operable to cause the at least one computing device to process a plurality of profiles to determine the values associated with the particular characteristic of the other users, with whom the particular user is determined to have the social ties.

16. The computer program product of claim 15, wherein:
the plurality of profiles include profiles related to use of the service.

17. The computer program product of claim 15, wherein:
the plurality of profiles include profiles not related to use of the service.

18. The computer program product of claim 14, wherein:
the computer program instructions are further operable to cause the at least one computing device to monetize the predicted value for the particular characteristic of the particular user.

19. The computer program product of claim 18, wherein:
the monetizing includes selling advertising to be caused to be displayed to at least the particular user.

20. The computer program product of claim 18, wherein:
the monetizing includes selling advertising to be caused to be displayed to at least the particular user, via the network.

21. The computer program product of claim 19, wherein:
the computer program instructions are further operable to cause the at least one computing device to determine requested compensation for the advertising is based at least in part on the predicted value for the particular characteristic of the particular user.

22. The computer program product of claim 14, wherein:
the computer program instructions operable to cause the at least one computing device to predict the value for the particular characteristic of the particular user includes, for each of the other users with whom the particular user is determined to have social ties, computer program instructions to cause the at least one computing device to apply a weighting to the value associated with the property of that other user based on an attribute of the connection via which the particular user exercises a social tie with that other user.

23. The computer program product of claim 22, wherein:
the attribute of the connection includes an attribute of the social tie exercised via the connection.

24. The computer program product of claim 22, wherein:
the attribute of the connection includes an attribute of the service provided on the connection via which the social tie is exercised.

25. The computer program product of claim 22, wherein:
the computer program instructions operable to cause the at least one computing to determine the weighting to apply to the value associated with the property of that other user include computer program instructions operable to cause the at least one computing device to employ at least one particular calibration user, for whom the value associated with the property is known, and determining the weighting based on, for each of a plurality of other calibration users with whom the at least one particular calibration user has social ties via the connections, other than the at least one particular calibration user, a value of the property of that other calibration user and an attribute of the connection via which the at least one particular calibration user has a social tie with that other calibration user.

26. A method of predicting a value for a particular characteristic of a particular person, comprising:
determining a plurality of other people, other than the particular person, with whom the particular user has social ties; and
predicting a value for the particular characteristic of the particular person based on values associated with the particular characteristic of the other people, with whom the particular person is determined to have the social ties.

27. The method of claim 26, further comprising:
processing a plurality of profiles to determine the values associated with the particular characteristic of the other people, with whom the particular person is determined to have the social ties.

28. The method of claim 27, wherein:
the plurality of profiles include profiles related to use of connections provided by network-based services.

29. The method of claim 27, wherein:
the plurality of profiles include profiles not related to use of connections provided by network-based services.

30. The method of claim 26, further comprising:
monetizing the predicted value for the particular characteristic of the particular person.

31. The method of claim 30, wherein:
the monetizing step includes selling advertising to be caused to be displayed to at least the particular person, via a network.

32. The method of claim 30, wherein:
determining requested compensation for the advertising is based at least in part on the predicted value for the particular characteristic of the particular person.

33. The method of claim 26, wherein:
the step of predicting the value for the particular characteristic of the particular person includes, for each of the other people with whom the particular person is determined to have social ties, applying a weighting to the value associated with the characteristic of that other person based on an attribute of a connection, provided by a network-based service, via which the particular person exercises a social tie with that other person.

34. The method of claim 33, wherein:
the attribute of the connection includes an attribute of the social tie exercised via the connection.

35. The method of claim 33, wherein:
the attribute of the connection includes an attribute of the service provided on the connection via which the social tie is exercised.
